(19) United States
(12) Patent Application Publication
(10) Pub. No.: US 2025/0034911 A1
(43) Pub. Date: Jan. 30, 2025

(54) DEVICE AND METHOD FOR STORING A LOCK

(71) Applicant: John Gillespie, Brooklyn, NY (US)

(72) Inventor: John Gillespie, Brooklyn, NY (US)

(21) Appl. No.: 18/441,498

(22) Filed: Feb. 14, 2024

Related U.S. Application Data
(60) Provisional application No. 63/515,203, filed on Jul. 24, 2023.

(51) Int. Cl. E05B 67/38

(52) U.S. Cl. CPC E05B 67/38; E05B 2067/386

(57) ABSTRACT

A device for keeping a lock with its key temporarily after the lock is unlocked and taken out from a hook to which the lock was secured. The device can be mounted to any supporting structure near the hook and forms a default place for keeping the locks after taking off from the hook. The device includes a casing in which the lock can be placed.

### CROSS-REFERENCE TO RELATED APPLICATIONS

This application claims priority from a U.S. provisional patent application Ser. No. 63/515,203, filed on Jul. 24, 2023, which is incorporated herein by reference in its entirety.

### FIELD OF INVENTION

The present invention relates to a device for keeping locks, and more particularly, the present invention relates to a method for temporarily keeping the locks.

### BACKGROUND

Portable locks, also referred to as padlocks, are widely used because of their versatility. The padlocks are easy to install and do not require any installation. The padlocks can be manufactured in different strengths for different levels of safety. The padlocks can be easily replaced and repaired without needing any modification in the structure to be secured.

Thus, the padlocks have many advantages, however, the versatility of the padlocks results in one major drawback. The locks upon being opened must be temporarily kept somewhere. Often it happens many times that a user forgets the placement of the lock. It may be time-consuming to find the lock and often becomes frustrating. Also, a user may be in a hurry and not have the time to look for the lock.

A need is therefore appreciated for a device and method for safekeeping a lock with its key temporarily after opening the lock.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

In one aspect, disclosed is a method for keeping a lock temporarily, the lock being secured to hooks, the method comprising providing a device, the device has a casing configured to receive the lock; mounting the device in proximity to the hooks, unlocking the lock from the hooks; and placing the lock into the casing of the device.

In one aspect, the device comprises a support member, the support member has a front face and a rear face, the casing is disposed on the front face, and a fastener is disposed on the rear face.

In one aspect, the fastener is a layer of adhesive and/or comprises screws.

In one aspect, the method further comprises removing the lock from the casing; and securing the lock to the hooks.

In one aspect, the casing has a closed bottom, side walls, and an open top. The open top is configured to receive the lock. The size of the casing corresponds to the size of the lock. The casing may be of a half-cylinder shape.

### BRIEF DESCRIPTION OF DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a front and side perspective view of the device, according to an exemplary embodiment of the present invention.

FIG. 2 shows the rear view of the device, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

Disclosed is a device that can temporarily keep a lock with its key and a method for safely keeping the lock during an interval between when the lock is opened and before the lock is used again. The device can safely keep the lock preventing the chances of missing the lock. The device can be installed near the hook so that a user opening the lock from the hook can place the lock with the device. Being within reach of the user, the user may automatically put the lock on the device. The position of the device near the hook for the best place to keep the lock with its key. Thus, by default, any user opening the lock may place the lock and its key in the disclosed device.

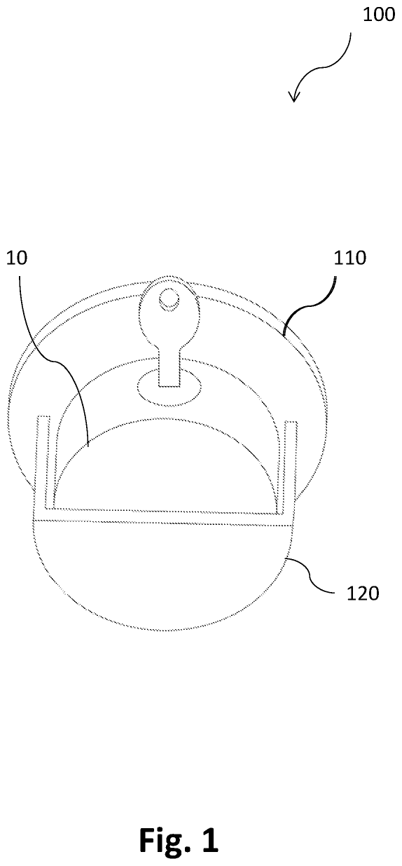

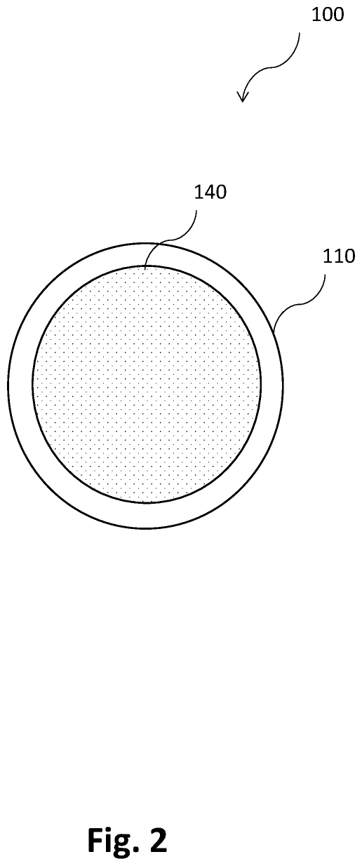

Referring to FIGS. 1 and 2, showing an exemplary embodiment of the disclosed device. The device 100 includes a support member 110. FIG. 1 shows the support member of a planar shape similar to a plate. The support members include a front face and a rear face. FIG. 1 shows the front face while FIG. 2 shows the rear face.

The device includes a casing 120 disposed on the front face of the support member. In one case, a housing with the front face of the support member forms the casing. The casing includes a closed bottom and side walls, while the top of the casing is open for receiving lock 10. The lock can be placed into the casing from the open top. The size of the casing may be just enough to accommodate the lock. The open top may be just wide enough to receive the lock. The smaller size of the device may be preferred for a variety of reasons, such as taking up less space, easy installation, and aesthetic appearance. Moreover, the just-to-fit size of the casing may prevent storing or dropping other articles into the casing. Drawings show the casing of a half-cylinder shape; however, any other shape of the casing is within the scope of the present invention.

On the rear side of the support member can be disposed a fastener 140 that may allow mounting the device to any supporting structure. The fastener can be a layer of adhesive that allows quick mounting of the disclosed device. The adhesive layer can be protected by a release liner. The release liner can be removed to adhere the device to a supporting structure. The adhesive can be a pressure-sensitive adhesive or any other suitable adhesive. The fastener can also be a hook and loop fastener, screws, bolts, and the like. The fastener can also be a bracket having snap-fit, friction fit, or a like mechanism for securely holding the device. The device can be mounted to a door, frame, wall, and the like supporting structures preferably near the hook.

The device including the support member and casing can be made from any suitable material, such as plastic, metal, and the like. The casing can be of 3.5×3.5 in dimensions.

In use, a user can unlock the lock from a hook, and then place the lock with its key in the casing of the device. When the lock has to be applied again, the user can pick the lock from the device and secure the same to the hooks again.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

1. A method for keeping a lock temporarily, the lock being secured to hooks, the method consisting of steps:
providing a device, the device consisting of:
a casing configured to receive the lock, the casing is of a half-cylinder shape, the casing has a closed bottom, side walls, and an open top, the open top is configured to receive the lock; and
a support member, the support member has a front face and a rear face, the casing is disposed on the front face, and an adhesive pad is disposed on the rear face;
mounting the device in proximity to the hooks;
unlocking the lock from the hooks;
upon unlocking, placing the lock into the casing of the device;
removing the lock from the casing; and
securing the lock to the hooks.

2. (canceled)

3. (canceled)

4. (canceled)

5. (canceled)

6. The method of claim 1, wherein a size of the casing corresponds to

7. (canceled)

8. (canceled)
